(19) United States
(12) Patent Application Publication
(10) Pub. No.: US 2026/0276419 A1
(43) Pub. Date: Sep. 17, 2026

(54) FLOW METER

(71) Applicant: SENTRONICS HOLDINGS LIMITED, Moordown (GB)

(72) Inventors: Andrew James Cawte, Moordown (GB); Neville John Meech, Moordown (GB); Anthony Charles Robert Stickland, Moordown (GB)

(73) Assignee: SENTRONICS HOLDINGS LIMITED, Moordown (GB)

(21) Appl. No.: 19/675,800

(22) Filed: May 13, 2026

Related U.S. Application Data
(63) Continuation of application No. PCT/GB2024/052916, filed on Nov. 18, 2024.

(30) Foreign Application Priority Data
Nov. 16, 2023 (GB) 2317599.5

(51) Int. Cl. G01F 1/667; G01F 1/66; G01F 15/00; G01F 15/14

(52) U.S. Cl. CPC G01F 1/667; G01F 1/662; G01F 15/006; G01F 15/14

(57) ABSTRACT

An acoustic flow meter is configured to determine a flow rate of a fluid flowing through a measurement channel by transmitting acoustic signals through the fluid. The flow meter comprises at least one transducer assembly that comprises a transducer carrier and a transducer mounted to the transducer carrier. The transducer is operable to transmit and/or receive the acoustic signals. The transducer carrier comprises a body that supports the transducer, and a passage that extends along a flow axis, through the body. The fluid flows through the passage, in use. The transducer carrier further comprises a transfer surface through which acoustic signals are transferred between the body and the fluid, in use. The transfer surface forms at least a portion of a surface of the passage. The transfer surface has an axial length that is shorter than a wavelength of the acoustic signals when propagating through the body.

### CROSS REFERENCE RELATED APPLICATIONS

This application claims the benefit under 35 U.S.C. 111(a) as a continuation of International Patent Application No. PCT/GB2024/052916, filed November 18, 2024, designating the United States and published in English, which claims priority under 35 U.S.C. §§ 119 and 365 to Great Britain Patent Application No. 2317599.5, filed November 16, 2023. The contents of each of the aforementioned applications are hereby incorporated by reference herein in their entirety.

### FIELD OF THE INVENTION

The present invention relates to acoustic flow meters, in particular ultrasonic flow meters, for measuring fluid flow rates.

### BACKGROUND TO THE INVENTION

Ultrasonic flow meters are in widespread use in a range of applications for the measurement of fluid flow rates. Known flow meters of this type operate on the principle that the propagation time of ultrasonic signals travelling through a fluid between two fixed points varies depending on whether the signal travels in the direction of flow or against the direction of flow, with signals propagating more quickly when travelling with the flow. Accordingly, the velocity of the fluid can be determined based on a difference in propagation times of ultrasonic signals travelling with and against the flow.

In a typical configuration, which may be referred to as a ‘ping-pong’ arrangement, two transducers are positioned opposite one another at respective ends of an enclosed fluid channel of known dimensions, so that fluid flowing through the fluid channel flows between the transducers. Each transducer acts in turn as both emitter and receiver. An ultrasonic signal, namely a short, periodic pressure wave at 18 kHz or above, is emitted by one of the transducers to travel in the direction of fluid flow, while the other transducer acts as receiver. On detecting the signal at the receiving transducer, the time-of-flight of the first signal is determined. Then, the roles of the transducers are reversed and a second ultrasonic signal is transmitted in the opposite direction to the first to travel against the direction of fluid flow, and its time-of-flight is determined. The difference in time-of-flight of the two signals is then compared and the fluid velocity can be derived using the known length and cross-sectional area of the channel.

An important performance metric for an ultrasonic flow meter is its signal-to-noise ratio (SNR). In this respect, when defining an SNR for a flow meter, the ‘signal’ refers to a signal that propagates along an intended path through the fluid to the receiving transducer, which may be referred to as the ‘wanted signal.’ Conversely, the ‘noise’ of the SNR refers to other signals that may be received or detected by the receiving transducer, which may be referred to as ‘unwanted signals.’ Unwanted signals may arise in the form of echoes from previous measurements, for example, or as parasitic signals that have taken an unintended path from the transmitting transducer to the receiving transducer. For example, a parasitic signal may propagate through a wall of the flow meter, instead of through the fluid. As the speed of sound in the solid material of the wall is typically higher than in the fluid, the parasitic signal may reach the receiving transducer more quickly than the wanted signal, or otherwise interfere with the wanted signal, thus distorting the measurements.

Efforts to improve the SNR in ultrasonic flow meters often involve adding damping material configured to absorb the energy of unwanted signals and so weaken their impact on the measurements. Practical limits constrain the level of damping that can be implemented, however. Moreover, while damping may dissipate energy lingering in the fluid channel and the solid components of the flow meter itself after the measurement has completed quickly and therefore enable signals to be sent at a higher rate, increasing the bandwidth of the flow meter, the effect of damping on the primary measurement signals, and therefore on noise, may be more limited.

It is against this background that the present invention has been devised.

### SUMMARY OF THE INVENTION

An aspect of the invention provides an acoustic flow meter, for example an ultrasonic flow meter. The flow meter is configured to determine a flow rate of a fluid flowing through a measurement channel by transmitting acoustic signals, for example ultrasonic signals, through the fluid. The flow meter comprises at least one transducer assembly that comprises a transducer carrier and a transducer mounted to the transducer carrier. The transducer is operable to transmit and/or receive the acoustic signals.

The transducer carrier comprises a body that supports the transducer, and a passage that extends along a flow axis, through the body. The fluid flows through the passage, in use. The transducer carrier further comprises a transfer surface through which acoustic signals are transferred between the body and the fluid, in use. The transfer surface forms at least a portion of a surface of the passage. The transfer surface has an axial length, with respect to the flow axis, that is shorter than a wavelength of the acoustic signals when propagating through the body. The transfer surface may have an axial length corresponding to half of a wavelength of the acoustic signals when propagating through the body.

In other words, the axial length of the transfer surface may be approximately equal to half of the wavelength of the acoustic signals when propagating through the body, and more specifically the wavelength of the acoustic signals when propagating through the body in a direction substantially parallel to the flow axis, which may also be referred to as the longitudinal mode of propagation. In this respect, the axial length of the transfer surface may be within 10%, and optionally 5% or even 2.5%, of half of the wavelength of the acoustic signals when propagating through the body. Dimensioning the transfer surface in this way helps to promote the efficiency of transfer of the acoustic energy between the fluid and the body of the carrier. For example, the dimensions may provide for pistonic motion of the transfer surface when excited by an acoustic signal, which in turn enhances displacement of fluid and therefore coupling of the signal into the fluid.

The body of the transducer carrier may comprise a mounting surface for receiving the transducer. The body may comprise a support member extending outwardly relative to the passage, in which case the mounting surface is defined by an annular surface of the support member that extends around the passage. The mounting surface may be flat. The mounting surface may extend in a plane transverse to the flow axis. The mounting surface may be axially offset from the transfer surface with respect to the flow axis. Such embodiments may provide for a robust connection of the transducer to the carrier, as well as easing assembly.

The passage of the transducer carrier may be fully enclosed by the body, so that the passage defines a sealed flow passage.

Optionally, the transfer surface forms a portion of a surface of the measurement channel and is exposed to fluid, in use. It is also possible for the transducer carrier to include a coating that covers the transfer surface and therefore isolates the transfer surface from the fluid.

The passage may comprise at least one relatively large diameter portion and a relatively small diameter portion, the transfer surface being defined by a surface of the small diameter portion. The small diameter portion may be disposed between a pair of large diameter portions, which large diameter portions may have equal diameters.

An outer surface of the body of the transducer carrier may comprise a groove or recess that extends around the passage. The groove or recess may be axially aligned with the transfer surface. The groove or recess may extend adjacent to a base of the support member, if present. The groove or recess may create a thin-walled region of the transducer carrier that serves to promote the transfer of acoustic signals into the fluid.

The body of the transducer carrier may be formed of a material having an acoustic impedance that is lower than the acoustic impedance of the transducer. The body may be formed of a material having an acoustic impedance that is between the acoustic impedance of the fluid and the acoustic impedance of the transducer. The body may be formed of a plastics material, such as PEEK.

The body of the transducer carrier may comprise an interface for coupling the transducer carrier to a flow tube of the flow meter. The interface may comprise a thread, or the interface may be configured for an interference fit, an adhesive bond or an O-ring interface with the flow tube. The passage may extend through the interface.

The transfer surface may be cylindrical, and may be centred on the flow axis.

The transducer assembly may comprise adhesive between the transducer and the transducer carrier.

A liner may be received in the, or each, large diameter portion of the passage of the, or each, carrier, if present. The, or each, liner may be of a different material to the body of the associated transducer carrier. The, or each, liner is optionally of a material with a higher acoustic impedance than the transducer carrier body. The, or each, liner is optionally of a material with an acoustic impedance that does not lie between an acoustic impedance of the transducer carrier body and an acoustic impedance of the fluid. The, or each, liner may be of metal, for example steel. The, or each, liner may be tubular and may have an inner diameter corresponding to a diameter of the transfer surface. The liners may help to control transfer of acoustic signals between the body and the fluid, for example by resisting transfer of energy between the body and the fluid at positions other than through the transfer surface.

The flow meter may comprise a flow tube, in which case the transducer assembly may be coupled to an end of the flow tube. The flow tube may enclose a passage that defines a portion of the measurement channel. The passage of the flow tube may align and communicate with the passage of the transducer carrier.

The flow meter may comprise a transducer assembly at each end of the flow tube.

The flow tube may be of a different material to the or each transducer carrier. The flow tube may be of a material with a higher acoustic impedance than the transducer carrier body. The flow tube may be of a material with an acoustic impedance that does not lie between an acoustic impedance of the transducer carrier body and an acoustic impedance of the fluid. The flow tube may be of metal, such as steel.

Optionally, the flow tube is straight. Alternatively, at least a portion of the flow passage may be curved.

The flow meter may comprise a controller configured to operate the or each transducer to transmit and/or receive acoustic signals. The controller may be configured to issue control signals to the or each transducer to cause the transducer to transmit acoustic signals, and to receive measurement signals indicative of detection of an acoustic signal from the or each transducer. The controller may be arranged internally or externally of a housing of the flow meter, for example.

Another aspect of the invention provides a method of operating a flow meter, for example an ultrasonic flow meter. The flow meter comprises a transducer assembly comprising a transducer carrier and a transducer supported by a body of the transducer carrier. The transducer carrier comprises a passage that extends along a flow axis, through the body, and a transfer surface through which acoustic signals are transferred between the body and fluid flowing through a measurement channel of the flow meter. The transfer surface forms at least a portion of a surface of the passage. The method comprises operating the transducer to transmit an acoustic signal having a frequency corresponding to an axial length of the transfer surface. The frequency of the acoustic signal may be such that the signal has a wavelength in the material of the transducer carrier body that is longer than the axial length of the transfer surface. The wavelength may correspond to, in other words be approximately equal to, double the axial length of the transfer surface.

The method may be performed on the flow meter of the above aspect. The invention also extends to a controller for a flow meter, the controller being configured to perform the method of the above aspect.

Another aspect of the invention provides a transducer carrier for an acoustic flow meter, for example an ultrasonic flow meter. The flow meter is configured to determine a flow rate of a fluid flowing through a measurement channel by transmitting acoustic signals, for example ultrasonic signals, through the fluid. The transducer carrier comprises a body configured to support a transducer that is operable to transmit and/or receive the acoustic signals, and a passage that extends along a flow axis, through the body. The fluid flows through the passage, in use. The transducer carrier further comprises a transfer surface through which acoustic signals are transferred between the body and the fluid, in use. The transfer surface forms at least a portion of a surface of the passage. The transfer surface has an axial length, with respect to the flow axis, that is shorter than a wavelength of the acoustic signals when propagating through the body. The transfer surface may have an axial length corresponding to half of a wavelength of the acoustic signals when propagating through the body.

Another aspect of the invention provides a transducer carrier for an acoustic flow meter, for example an ultrasonic flow meter. The flow meter is configured to determine a flow rate of a fluid flowing through a measurement channel by transmitting acoustic signals, for example ultrasonic signals, through the fluid. The transducer carrier comprises: a body configured to support a transducer that is operable to transmit and/or receive the acoustic signals, the body comprising an outwardly extending support member defining an annular mounting surface for receiving the transducer; a passage that extends along a flow axis, through the body and the support member. The fluid flows through the passage, in use. The transducer carrier further comprises a transfer surface through which acoustic signals are transferred between the body and the fluid, in use. The transfer surface forms at least a portion of a surface of the passage. The transfer surface may have an axial length that is shorter than, and optionally corresponds to half of, a wavelength of the acoustic signals when propagating through the body.

The invention also extends to a transducer assembly comprising the transducer carrier of either of the above aspects and a transducer mounted to the transducer carrier.

Another aspect of the invention provides a flow tube assembly, comprising a flow tube and a transducer assembly according to the above aspect coupled to an end of the flow tube. The flow tube may enclose a passage that defines a portion of the measurement channel. The passage of the flow tube may align and communicate with the passage of the transducer carrier. The flow tube assembly may comprise a transducer assembly at each end of the flow tube. The flow tube may be of a different material to the or each transducer carrier. The flow tube may be of a material with a higher acoustic impedance than the transducer carrier body. The flow tube may be of a material with an acoustic impedance that does not lie between an acoustic impedance of the transducer carrier body and an acoustic impedance of the fluid. The flow tube may be of metal, such as steel. Optionally, the flow tube is straight. Alternatively, at least a portion of the flow passage may be curved.

The invention also extends to a flow meter, for example an ultrasonic flow meter, comprising the transducer carrier, the transducer assembly or the flow tube assembly of any of the above aspects.

It will be appreciated that preferred and/or optional features of each aspect of the invention may be incorporated alone or in appropriate combination in the other aspects of the invention also.

### BRIEF DESCRIPTION OF THE DRAWINGS

In order that the invention may be more readily understood, preferred non-limiting embodiments thereof will now be described, by way of example only, with reference to the accompanying drawings, in which like features are assigned like reference numbers, and in which:

FIG. 1 is a schematic view of a flow meter according to an embodiment of the invention;

FIG. 2 shows a flow tube assembly of the flow meter of FIG. 1 in axial cross-section;

FIG. 3 shows a side view of a transducer carrier of the flow tube assembly of FIG. 2;

FIG. 4 shows an axial cross-sectional view taken through the line A-A in FIG. 3;

FIG. 5 shows an end view of the transducer carrier of FIG. 3;

FIG. 6 shows a transducer assembly of the flow tube assembly of FIG. 2 in axial cross-section;

FIG. 7 shows a flow tube of the flow tube assembly of FIG. 2 in perspective view;

FIG. 8 shows an end view of the flow tube of FIG. 7;

FIG. 9 shows a side view of the flow tube of FIG. 7;

FIG. 10 shows a transverse cross-sectional view taken through the line B-B in FIG. 9;

FIG. 11 shows an axial cross-sectional view taken through the line C-C in FIG. 9;

FIGS. 12a to 12g show a series of stages of a simulation of operating the flow tube assembly of FIG. 2; and

FIG. 13 shows a side view of a variant of the flow tube shown in FIGS. 7 to 11.

### DETAILED DESCRIPTION OF EMBODIMENTS OF THE INVENTION

In general terms, embodiments of the invention provide acoustic flow meters, particularly ultrasonic flow meters, for measuring fluid flow rates in a range of applications, and components for such flow meters. To provide some non-limiting examples, the fluid that the flow meter is used with may be paint in the context of use in a robotic spraying system, or the fluid may be vehicle fuel, such as diesel fuel for a marine engine.

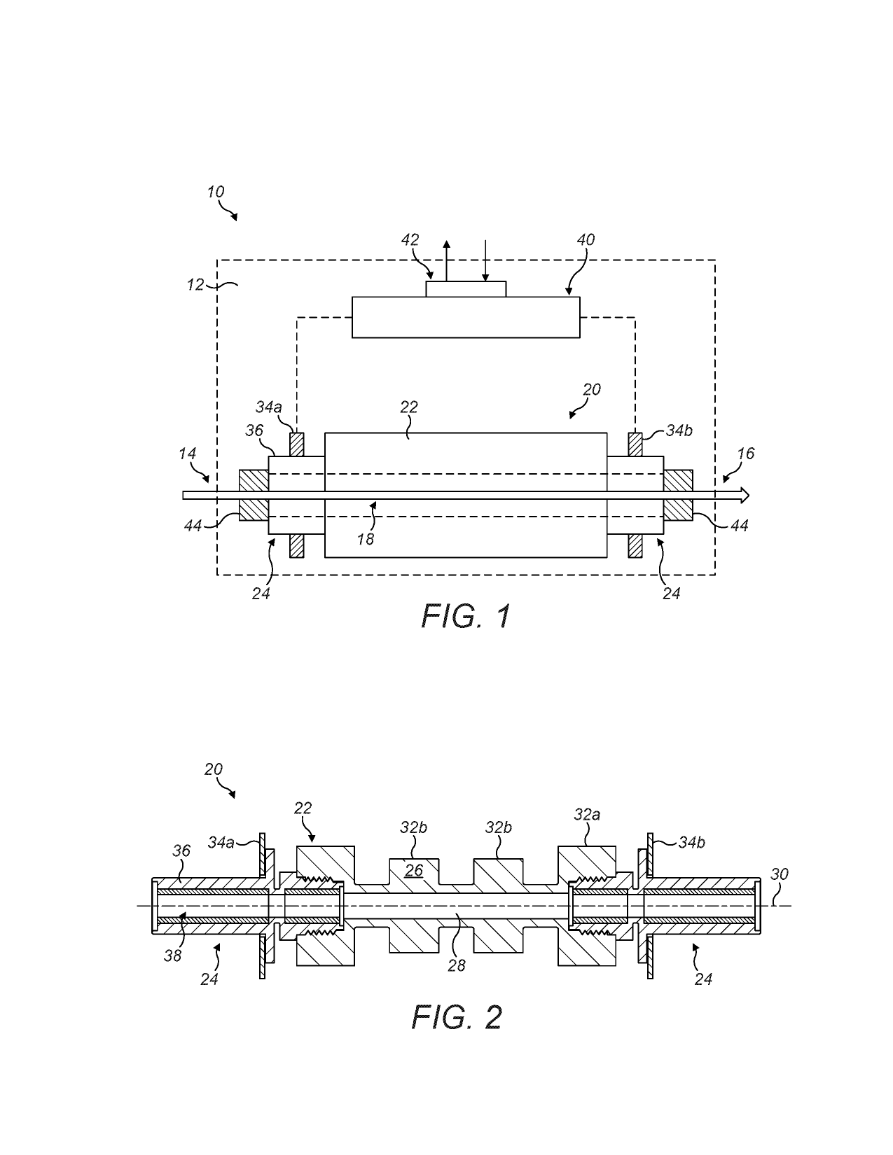

An example of an ultrasonic flow meter according to an embodiment of the invention is shown in simplified schematic form in FIG. 1. The flow meter 10 comprises a main housing 12 having an inlet port 14 for admitting fluid and an outlet port 16 for expelling fluid. A flow channel 18 is defined within the housing 12 to provide part of a fluid flow path between the inlet port 14 and the outlet port 16. In use, fluid enters the inlet port 14, flows through the flow channel 18 and exits through the outlet port 16, as indicated by the arrow in FIG. 1. The flow meter 10 can therefore be readily integrated into a fluid circuit of, for example, a vehicle or a paint spraying system.

The flow channel 18 is defined by and within a flow tube assembly 20 that is contained within the housing 12. The flow tube assembly 20 is shown in more detail in FIG. 2, which reveals that the flow tube assembly 20 includes an elongate, straight flow tube 22 carrying a transducer assembly 24 at each end.

The flow tube 22 comprises a wall 26 of, for example, steel, that encloses a hollow cylindrical interior defining a straight central bore or passage 28 of uniform diameter, which represents a portion of the flow channel 18. The central passage 28 extends along a central longitudinal axis of the flow tube 22, which corresponds to a central axis 30 of the flow channel 18 and the flow tube assembly 20. The central axis 30 defines a flow axis for the flow tube assembly 20.

The transverse profile of the wall 26 varies axially. More specifically, the wall 26 is shaped to create an axial series of mutually-spaced block-like formations 32, hereafter referred to simply as ‘blocks’, which are axially spaced-apart to define intervening spaces between them, as described in more detail later.

Each transducer assembly 24 comprises a transducer 34 and a transducer carrier 36 to which the transducer 34 is mounted. Accordingly, the flow tube assembly 20 includes first and second opposed transducers, 34a, 34b, disposed near respective ends of the flow channel 18, to provide a means for measuring the flow rate of fluid travelling through the flow channel 18, between the transducers 34a, 34b. The portion of the flow channel 18 extending between the transducers 34 therefore defines a measurement channel for fluid flow.

The first transducer 34a is positioned at an end of the flow channel 18 nearest the inlet port 14, and the second transducer 34b is located at the opposite end of the flow channel 18 nearest the outlet port 16.

The transducers 34 have the general form of flat annular discs having a central opening, and may be any suitable components that are capable of converting an AC electrical input signal into an ultrasonic signal, and vice-versa, including piezoelectric transducers or capacitive transducers for example. Transducers of different geometries may also be used in other examples, with suitably adapted transducer carriers.

Each transducer 34 is configured to operate in turn in a transmitter mode and a receiver mode. Thus, the transducers 34 may alternatively be referred to as transceivers.

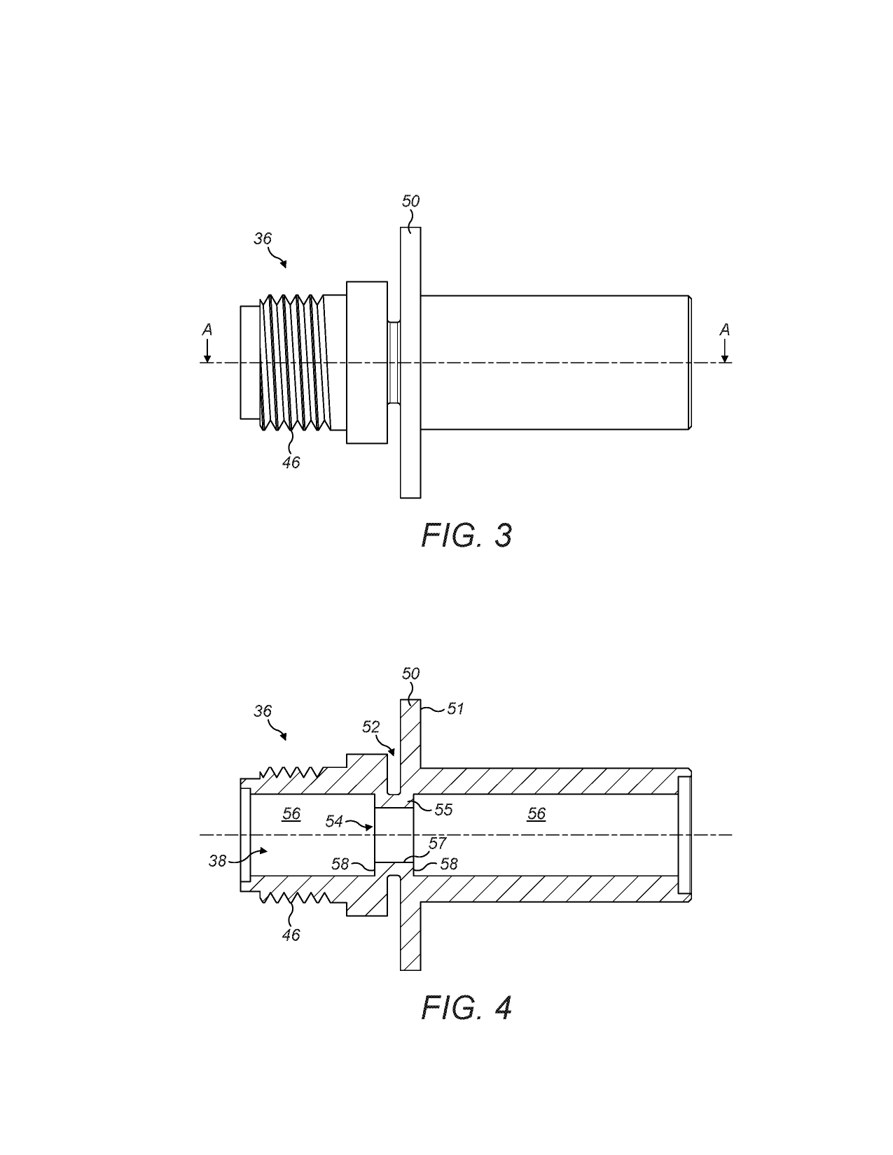

The transducer carrier 36, which can be seen more clearly in FIGS. 3 to 5, has a generally tubular body with a central bore 38 extending along an axis defining a central axis of the transducer carrier 36, which is coaxial with the central axis 30 of the flow tube assembly 20.

In the flow tube assembly 20, the transducer carriers 36 are mounted to respective ends of the flow tube 22 so that the central passage 28 of the flow tube 22 aligns and communicates with the respective bores 38 of the transducer carriers 36. The central passage 28 and the bores 38 therefore collectively create a continuous passage defining the flow channel 18.

Returning to FIG. 1, the flow meter housing 12 also accommodates a control module 40, which includes circuitry configured for controlling operation of the transducers 34 and for determining and processing time-of-flight measurements for signals sent between the transducers 34, to ascertain the flow rate of fluid flowing through the flow channel 18. For this purpose, the control module 40 is connected to each of the transducers 34 by communication lines represented by dashed lines in FIG. 1, which enable control signals, or ‘drive signals,’ to be issued to the transducers 34 and measurement signals to be received from the transducers 34. The control module 40 further includes an I/O interface 42 providing for external electrical connections to and from the flow meter 10, for example to enable user input and to output flow rate measurements.

The control module 40 acts to switch the transducers 34 between transmitter and receiver modes, to determine and control the characteristics of ultrasonic signals emitted by the transducers 34 by issuing appropriate electrical activation signals, and to process returning electrical signals from the transducers 34 associated with detection of ultrasonic signals, to derive values for flow rates of fluid within the flow channel 18.

When in the transmitter mode, each transducer 34 transmits a respective ultrasonic signal into the flow channel 18 toward the opposite transducer 34, so that the ultrasonic signal travels through any fluid present in the measurement channel. Each ultrasonic signal comprises a periodic pressure wave defining a pulse or pulse train having a frequency in the ultrasonic range, namely 18 kHz or above. In this example, the transducers 34 produce signals having a frequency of approximately 200kHz, which is a function of the characteristics of the transducers 34 and also the drive signals used to operate the transducers 34.

It is noted that it is possible for signals of lower frequency to be used, for example signals in the audible range. This entails larger transducers and in turn a flow channel 18 of greater diameter, and so may be practical in large industrial flow meters involving high flow rates, for example.

Although the control module 40 is illustrated as a single unit in the simplified representation provided by FIG. 1, in practice the control module 40 may be implemented in various ways, including in a more distributed manner with separate sub-modules for different functions. It is also possible for an external controller to be used, in which case the flow meter 10 includes terminals that enable communication between the controller and the transducers 34.

FIG. 1 also shows fluid ports 44 coupled to each end of the flow tube assembly 20, enabling fluid connections to be made to the flow tube assembly 20 to deliver fluid to, and collect fluid from, the flow channel 18.

As already noted, an ultrasonic signal travelling in the direction of fluid flow takes less time to reach the opposite transducer 34 than a signal travelling against the flow. Since the first transducer 34a is in an upstream position, signals transmitted from the first transducer 34a travel in the direction of fluid flow. Conversely, the second transducer 34b sends signals in the opposite direction and therefore against the direction of fluid flow. The signals transmitted from the first transducer 34a will therefore propagate through the flow channel 18 more quickly than signals transmitted by the second transducer 34b. Thus, the fluid flow rate may be derived from a difference in the respective time-of-flight measurements for signals travelling in opposite directions. It is also noted that if fluid is present in the measurement channel but not flowing, similar time-of-flight measurements in each direction may be expected.

It is noted that the flow meter 10 shown in FIG. 1 is inherently bi-directional and so is capable of operating in reverse, such that fluid flows from the outlet port 16 to the inlet port 14.

With reference again to FIGS. 3 to 5, the transducer carrier 36 is now considered in more detail. In general terms, the transducer carrier 36 provides mechanical support to the transducer 34, to hold the transducer 34 relative to the flow tube 22 in a position that is spaced from the flow tube 22, so that the transducer 34 is isolated from the flow tube 22. The transducer carrier 36 also acts as an interface between the transducer 34 and fluid flowing through the flow channel 18, by providing an acoustic path for vibration to couple between the transducer 34 and the fluid.

In this example, the transducer carrier 36 is configured to support the transducer 34 externally, so that the transducer 34 is isolated from fluid flowing within the bore 38 of the transducer carrier 36, through the flow channel 18. In other words, the transducer 34 is not in contact with the fluid whose flow rate is to be measured. This may be beneficial for reasons other than controlling acoustic behaviour. For example, isolating the transducer 34 physically from the fluid also provides corresponding electrical isolation, which may be useful if the fluid is flammable.

Accordingly, the transducer carrier 36 acts both to support the transducer 34 relative to the flow tube 22 and to provide an interface between the transducer 34 and the fluid. The transducer carrier 36 is configured to transfer the acoustic energy of the signals generated by the transducer 34 into the fluid within the bore 38 in an efficient and effective manner, minimising the proportion of each signal that does not reach the fluid and that could therefore become a parasitic signal that propagates through the solid walls of the flow tube assembly 20.

In this example, the transducer carrier 36 is defined by a body of PEEK (Polyether ether ketone), which advantageously has a relatively low acoustic impedance whilst being a mechanically stable and robust material that is compatible for use with a range of fluids. PEEK also has a relatively low coefficient of thermal expansion, and so helps to minimise the sensitivity of the flow meter 10 to temperature variations. Other materials may be used for the transducer carrier in other examples, for example other plastics or, more generally, any material that is an efficient conductor of acoustic energy. In this respect, the material selected for the transducer carrier 36 typically has an acoustic impedance that lies between that of the transducer 34 itself and that of the fluid that will flow through the flow meter 10.

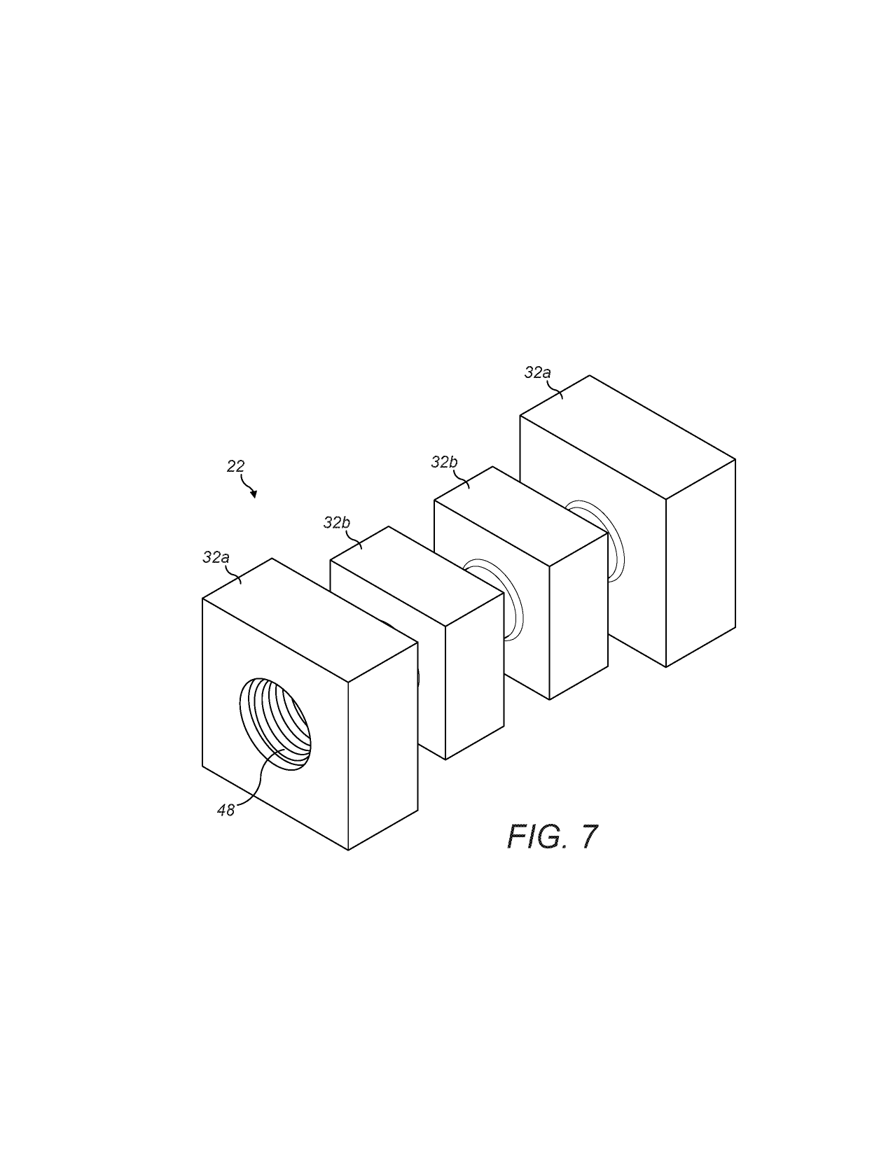

The body of the transducer carrier 36 includes an end portion defining an engagement formation 46 carrying a male thread. This male thread 46 is configured to engage with a corresponding female thread 48 formed in an end region of the central passage 28 of the flow tube 22, which is shown in FIG. 7, to define a threaded interface by which the transducer carrier 36 is attached to the flow tube 22. The end portion of the body of the transducer carrier 36 therefore defines an interface by which the transducer carrier 36 can be coupled to the flow tube 22. In other examples, the transducer carriers 36 may have a different type of interface for mounting the carrier 36 to the flow tube 22 in other ways, including press-fit interfaces, adhesive interfaces, and O-ring interfaces, for example.

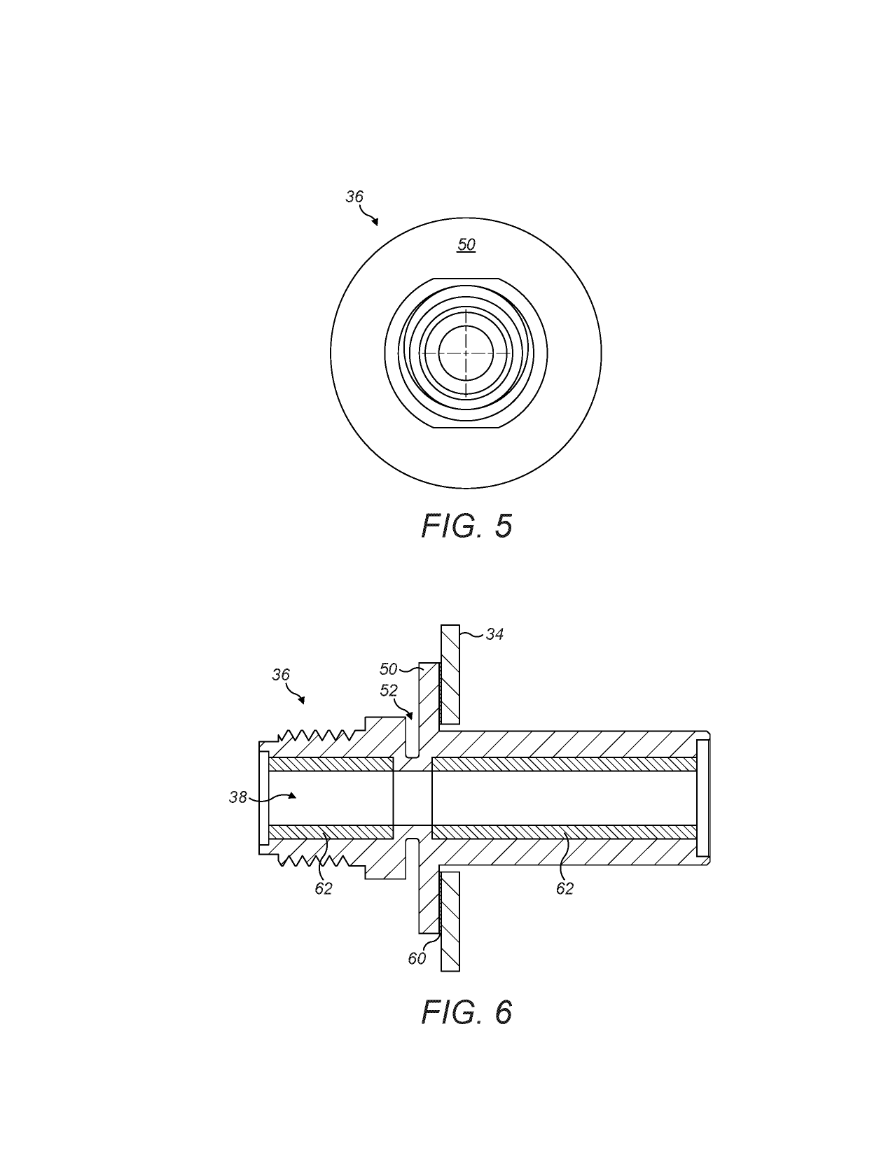

FIG. 5 shows a pair of flats on upper and lower sides of the engagement formation 46, adjacent to the male thread, which aid assembly of the flow tube assembly 20. Aside from these flats and the male thread of the engagement formation 46, the transducer carrier 36 has circular symmetry about its central axis in this example.

Adjacent to the engagement formation 46, the transducer carrier 36 further includes a transducer support member in the form of a radial flange 50 that supports a respective transducer 34. Specifically, a planar surface of the flange 50 extending in a plane orthogonal to the central axis, on the opposite side of the flange 50 to the engagement formation 46, defines a transducer mounting surface 51 that is annular in form, to complement the annular shape of the transducer 34 it is to receive. It follows that the transducer mounting surface 51 extends around the central axis of the transducer carrier 36 to surround the bore 38. It is noted that a transducer 34 can be mounted to either side of the flange 50, such that each of the parallel planar faces of the flange 50 may be regarded as transducer mounting surfaces.

The transducer carrier 36 further includes a groove 52 that extends radially into the body of the transducer carrier 36 and circumferentially around the base of the flange 50, between the flange 50 and the engagement formation 46. The groove 52 creates a thin-walled region of the transducer carrier 36 having a minimum radial thickness, which serves to promote the transfer of ultrasonic signals generated by a transducer 34 into fluid within the bore 38.

The bore 38 of the transducer carrier 36 includes a narrow portion 54 of reduced diameter created by an inwardly-extending radial projection defining a ring formation 55 of the transducer carrier body. The ring formation 55 is in axial alignment with the groove 52, so that the groove 52 extends circumferentially around the narrow portion 54 of the bore 38. The ring formation 55 is axially offset from the transducer mounting surface 51. The axial length of the ring formation 55 is approximately half the wavelength that the signals produced by the transducer 34 have in the PEEK material of the carrier 36, which further promotes the efficiency of transfer of the acoustic energy into the fluid. In this respect, it is noted that PEEK and other materials from which the carrier 36 may be fabricated may have multiple different values for speed of sound relating to different propagation modes, including one value relating to a longitudinal mode of propagation and a second value relating to a shear mode of propagation. In this example, the axial length of the ring formation 55 corresponds to the speed of sound, and the corresponding wavelength, associated with the primary, or fastest, mode of propagation in the material of the carrier 36, which is the longitudinal mode of propagation. In other words, the axial length of the ring formation 55 corresponds to half of the wavelength of a signal propagating through the transducer carrier body in a direction parallel to the flow passage 18.

The axial width of the groove 52 corresponds to approximately half the axial length of the ring formation 55 in this example. The ring formation 55 has a cylindrical inner surface having a diameter, which also defines the diameter of the narrow portion 54 of the bore 38, that is equal to the diameter of the central passage 28 of the flow tube 22.

The cylindrical inner surface of the ring formation 55 defines a transfer surface 57, through which acoustic signals are transferred between the transducer 34 and the fluid, in use. The transfer surface 57 is directly exposed to the fluid and forms part of the surface of the flow channel 18.

The bore 38 is wider on each side of the narrow portion 54, defining a pair of wider portions 56 that are of equal diameter to one another in this example. Planar side faces of the ring formation 55 extending in parallel radial planes define a pair of shoulders 58 at the interfaces between the narrow portion 54 and each of the wider portions 56.

The remaining portion of the body of the transducer carrier 36, which is shown to the right of the flange 50 in FIGS. 3 and 4 and accounts for approximately two-thirds of the axial extent of the transducer carrier 36, has the form of a straight tube. FIG. 4 shows that the bore 38 is counter-bored at an end to the right, in the orientation shown in FIG. 4, to define a socket that is configured to receive a corresponding complementary formation of a fluid port 44.

FIG. 6 shows the transducer assembly 24, which includes a transducer 34 mounted to the flange 50 of the transducer carrier 36, on the transducer mounting surface 51. Specifically, the transducer 34 is secured to the flange 50 by a layer 60 of adhesive between the transducer 34 and the transducer mounting surface 51. Accordingly, a planar attachment interface is defined between the transducer 34 and the transducer carrier 36 in this example, that interface extending in a radial plane.

The planar attachment interface features a high degree of overlap between the transducer 34 and the transducer carrier 36. This ensures high-integrity contact between these components, achieving efficient transfer of energy into the material of the transducer carrier 36, as well as a mechanically strong adhesive bond. Alternatively, the flange 50 may be omitted and the transducer 34 bonded directly to the outside curved surface of the carrier 36.

The diameter of the central opening of the transducer 34 may be larger than the outer diameter of the portion of the transducer carrier 36 that the transducer 34 surrounds, namely the portion to the right of the flange 50 in the orientation shown in FIG. 6. This facilitates assembly by allowing the transducer 34 to be slid onto the carrier 36 from the right-hand side as shown. Accordingly, as FIG. 6 shows, a small radial clearance may exist between the cylindrical exterior of the transducer carrier 36 and the inner edge of the transducer 34.

The transducer assembly 24 further includes steel tubes defining liners 62 that are each received in a respective one of the wider portions of the bore 38, to abut a respective shoulder 58. The liners 62 have an outer diameter commensurate with the diameter of the wider portions of the bore 38, and an inner diameter equal to the inner diameter of the ring formation 55 of the transducer carrier 36. Accordingly, the liners 62, when in place, cooperate with the transfer surface 57 to create a passage of substantially uniform diameter within the transducer carrier 36, which passage defines a portion of the flow channel 18.

In turn, the passage created by the liners 62 and the transfer surface 57 is of the same diameter as the central passage 28 of the flow tube 22. The interfaces between the liners 62, the ring formations 55 of the transducer carriers 36 and the central passage 28 of the flow tube 22 are configured to minimise interruptions to the diameter of the flow channel 18, so that an inner surface of the flow channel 18 is substantially smooth. The smoothness of the flow channel 18 is also aided by arranging the transducers 34 so that they are not in contact with the fluid, using the transducer carriers 36 as interfaces between the fluid and the transducers 34.

Providing a substantially smooth and straight flow channel 18 has various benefits. In general terms, a straight tube minimises the pressure drop between the ends of the flow channel 18. Also, if the flow meter 10 is used for measuring a flow rate of paint, the channel 18 is substantially free of crevices that could act as paint traps, enabling the flow meter 10 to be used with paints of different colours without cross-contamination. The smoothness of the flow channel 18 also minimises the risk of gas bubbles becoming trapped in the flow channel 18, particularly if the flow meter 10 is mounted vertically, which in turn eases purging of the flow meter 10. It is noted that the channel 18 may not be smooth in other examples, however, for example if the liners 62 have a different inner diameter to the ring formation 55 of the carrier 36, or the inner diameter of the transfer surface 57 differs from that of the central passage 28 of the flow tube 22.

The passage created within the transducer carrier bore 38, which represents part of the flow channel 18, comprises a cylindrical surface composed of two steel portions separated by a narrow ring of plastics material, the steel portions corresponding to the inner surfaces of the liners 62 and the plastics portion corresponding to the transfer surface 57. The transfer surface 57 thus provides a portion of the acoustically-conductive body of the transducer carrier 36 that is in direct contact with fluid flowing through the flow channel 18 in this example. This provides for effective acoustic coupling between the associated transducer 34 and the fluid in the flow channel 18, by configuring the transducer carrier 36 to provide an acoustic impedance gradient such that it acts as an efficient matching layer between the transducers 34 and the fluid. This effect is enhanced by the fact that the transfer surface 57 is directly adjacent to the mounting flange 50 and is located in a thin-walled portion of the transducer carrier 36 by virtue of the groove 52, thus guiding the acoustic signal along a path which brings it into close contact with the fluid, and so maximising the transfer of acoustic pressure from the transfer surface 57 to the fluid.

In this respect, in this example the transducer 34 acts to excite the material of the transducer carrier 36 so that the acoustic signal propagates through the transducer carrier body in a direction generally parallel to the central axis of the transducer carrier 36, and therefore parallel to the direction of fluid flow within the flow channel 18. The signal acts to constrict the carrier bore 38 radially by the Poisson effect, in turn displacing fluid within the bore 38 and so transferring acoustic energy to the fluid. The axial length of the transfer surface 57 in contact with the fluid is approximately half of a wavelength of the signals produced by the transducer 34 when propagating through the material of the carrier 36 in a direction parallel to the flow direction, which helps to maximise this fluid displacement and so promote transfer of acoustic energy into and out of the fluid.

Meanwhile, the use of liners 62 of a material having a significantly higher acoustic impedance than the material of the transducer carrier 36 acts to isolate and control the location at which the acoustic energy is injected into the fluid, and also resists transfer of acoustic energy back into the transducer carrier 36 from the fluid.

It is noted that the above principles regarding efficient coupling from the transmitting transducer 34 to the fluid also apply in reverse, such that acoustic energy is transferred effectively from the fluid through the transfer surface 57 of the carrier 36 associated with a receiving transducer 34, and then through the material of the carrier 36 to that transducer 34. Meanwhile, the liners 62 help to ensure that acoustic energy predominantly enters and leaves the material of the transducer carriers 36 through their respective transfer surfaces 57.

At the threaded interface between the transducer carrier 36 and the flow tube 22, the dissimilar materials create an impedance discontinuity that tends to reflect at least a portion of the energy of acoustic signals. Accordingly, the threaded interface effectively acts as a barrier that resists propagation of parasitic signals between the body of the transducer carrier 36 and the wall 26 of the flow tube 22 in either direction. So, when a signal is transmitted and a parasitic signal arises, the interface between the carrier 36 of the transmitting transducer 34 and the flow tube 22 represents a first barrier to the parasitic signal, and the interface between the flow tube 22 and the carrier 36 associated with the receiving transducer 34 represents a second barrier.

Accordingly, the transducer assembly 24 is configured to transmit acoustic signals efficiently and effectively between the transducers 34 and the fluid flowing within, yielding strong received signals at the receiving transducer 34, whilst resisting the propagation of parasitic signals. The transducer assembly 24 also contributes to a smooth and straight flow channel 18 for the flow meter 10.

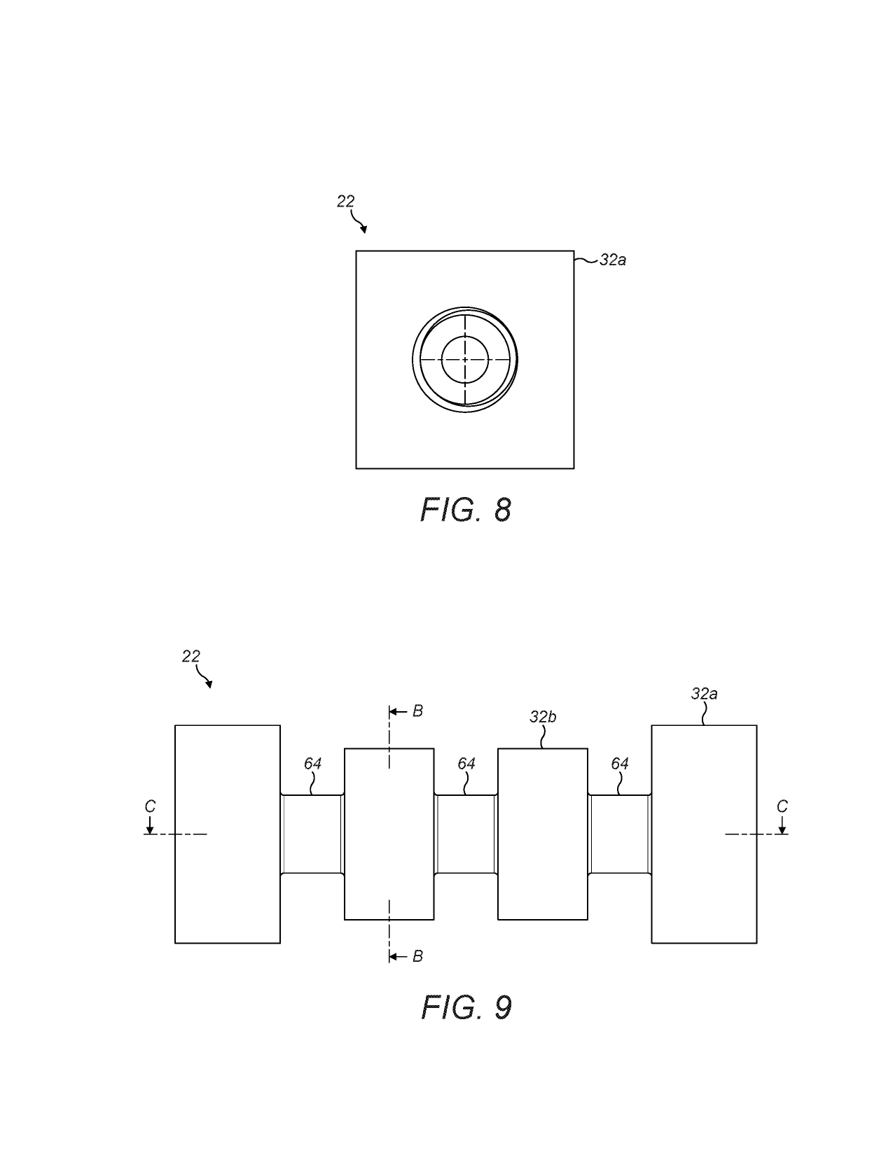

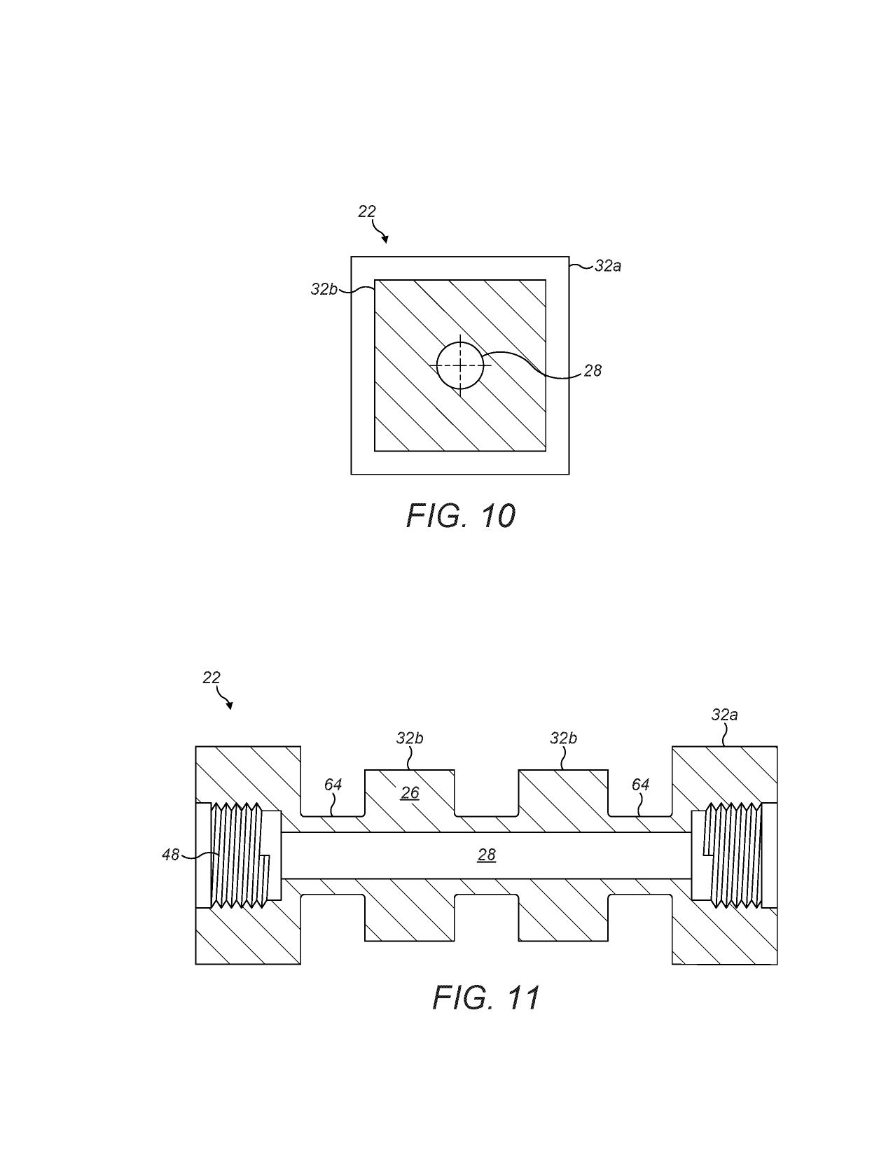

Turning now to the flow tube 22, and with reference to FIGS. 7 to 11 collectively, as noted above the exterior of the flow tube 22 is shaped to create a set of blocks 32 arranged in axial series along the exterior of the flow tube 22. These blocks 32 include a pair of end blocks 32a, one at each end of the flow tube 22, and a pair of intervening blocks 32b that are regularly spaced in axial succession between the end blocks 32a. The end blocks 32a are larger than the intervening blocks 32b in this example, which in part accounts for the space consumed to accommodate the female threads 48 and to receive the engagement formations of the transducer carriers 36. The end blocks 32a are identical to one another, and similarly the intervening blocks 32b are identical to one another.

As seen most clearly in FIGS. 7, 8 and 10, each block 32 has a square cross-section in a plane transverse to the central axis 30, the cross-section of each block 32 being uniform axially and being centred on the central axis 30. Each block 32 therefore extends circumferentially fully around the central axis 30. In this example, the end blocks 32a have a transverse width that is approximately five times the diameter of the flow channel 18, while the intervening blocks 32b have a transverse width that is approximately four times the diameter of the flow channel 18.

Neighbouring blocks 32 are connected by tubular portions 64 of the wall 26 of the flow tube 22, the flow tube 22 having three such tubular portions 64, which in this example are identical to, and coaxial with, one another. The tubular portions 64 are narrower than the blocks 32, and so intervening gaps or spaces are defined between each neighbouring pair of blocks 32 externally of the respective tubular portion 64, those spaces being generally annular. In this example, the outer diameter of the tubular portions 64 is less than twice the diameter of the flow channel 18, and the wall thickness of the tubular portions 64 is less than, but comparable to, the radius of the flow channel 18. In turn, the tubular portions 64 are thin relative to a wavelength of parasitic signals that may propagate through them.

In broad terms, the blocks 32 are relatively deep axially and so are to be distinguished from radial fins, for example. In this respect, each block 32 has an axial depth that exceeds, although is similar to, the axial distance between neighbouring blocks 32. In this example, the blocks 32 are approximately half as deep axially as they are wide transversely. Each block 32 therefore has four identical oblong side faces that extend in respective planes that are parallel to the central axis 30.

In this example, the blocks 32 are regularly spaced along the length of the flow tube 22, with the spacing corresponding to approximately half of the wavelength of parasitic signals propagating through the wall 26 of the flow tube 22, which in turn corresponds to half of the wavelength that the signals produced by the transducers 34 have in the steel material of the wall 26. In other words, the sum of the axial depth of a block 32 and the axial distance from that block 32 to the adjacent block 32 corresponds to, or in other words is approximately equal to, half of the wavelength of the transmitted signals in the wall 26 of the flow tube 22. This may also be referred to as the blocks 32 being spaced at a pitch corresponding to half of a wavelength of the parasitic signals.

More precisely, as noted above a material such as steel has multiple different values for speed of sound relating to different propagation modes, including one value relating to a longitudinal mode of propagation and a second value relating to a shear mode of propagation. In this example, the spacing of the blocks 32 of the flow tube 22 corresponds to the speed of sound, and the corresponding wavelength, associated with the primary, or fastest, mode of propagation in the material of the wall 26, which is the longitudinal mode of propagation. For this example, in which the signals have a frequency of 200kHz, the wave speed is approximately 5790m/s and the wavelength is approximately 29mm. Correspondingly, the intervening blocks 32b have an axial depth of 8.5mm and are spaced apart by 6.25mm, giving an overall spacing of 14.75 mm for the blocks 32, which is very close, but not precisely equal, to half of the wavelength.

Due to the square shape of the block potions 32, and ignoring the female threads 48, the flow tube 22 has four degrees of rotational symmetry about its central axis. The flow tube 22 also has a plane of symmetry that is orthogonal to the central axis and that intersects an axial midpoint of the flow tube 22.

As FIG. 11 makes clear, in this example the blocks 32 are formed integrally with the tubular portions 64, such that the wall 26 of the flow tube 22 comprises the blocks 32 and is a single homogeneous and integrated part. In other examples, however, the flow tube 22 could be fabricated as an assembly, for example by press-fitting separate blocks onto a core tube.

Since sound generally travels faster through solids than through fluids, parasitic signals propagating through the solid walls of the flow tube assembly 20 threaten to reach the receiving transducer 34 before the wanted signal, thereby distorting the measurements. To mitigate this, the blocks 32 are configured such that they collectively create an effective delay-line, which resists and thus slows the progress of parasitic signals that may propagate through the wall 26 of the flow tube 22. In consequence, the effective speed of each parasitic signal is reduced to a level that is below the speed of the corresponding wanted signal through the fluid. This has the effect of delaying parasitic signals as they travel from the transmitting transducer 34 to the receiving transducer 34 to a sufficient extent that the parasitic signals do not reach the receiving transducer 34 until after the corresponding wanted signal has propagated through the fluid and has been detected. Thus, the parasitic signals can be ignored to avoid distorting the measurements taken by the flow meter 10. For example, the receiving transducer 34 may be switched off after detecting the wanted signal, so that the parasitic signal is simply not detected.

It is noted that the delay-line effect provided by the blocks 32 is to be distinguished from damping as may be found in known flow meters. Conventional damping aims to absorb energy from parasitic signals, to lessen their impact on measurements and to increase the frequency at which measurements may be taken by dissipating energy lingering after each measurement. In contrast, the delaying effect created by the blocks 32 of the present example slows propagation of parasitic signals, without necessarily reducing the magnitude of the parasitic signals. In principle, the delay-line may be effective even if there is no damping at all, such that all of the energy of each parasitic signal eventually reaches the receiving transducer. As propagation of the parasitic signal is delayed so that it reaches the receiving transducer after the measurement is taken, the magnitude of the parasitic signal does not have an impact.

The effect of the flow tube 22 as a delay line to parasitic signals, together with the configuration of the transducer carrier 36 to couple acoustic signals effectively into the fluid while minimising the proportion of acoustic energy of each transmission that becomes a parasitic signal, collectively provide a very high SNR in the readings collected by the flow meter 10.

More specifically, the flow tube 22 delays parasitic signals by tuning the geometry, shape and spacing of the blocks 32, according to the frequency of the signals to be transmitted and the material of the wall 26, such that a standing wave is formed in the wall 26 of the flow tube 22 that has nodes located between the blocks 32, in the tubular portions 64. In this respect, the spacing of the blocks 32 enables the nodes to locate in the spaces between the blocks 32, since the standing wave has the same wavelength as the original parasitic signal and has two nodes for each full cycle, those nodes therefore being half a wavelength apart. It follows that the spacing of the blocks 32 tunes the flow tube 22 to delay parasitic signals of a particular frequency, and a small range around that frequency.

More specifically, the spacing or pitch of the blocks 32 corresponds to half of the wavelength of the signals, meaning that the blocks 32 are spaced at intervals that are each approximately equal to half of the wavelength of the signals, albeit not precisely equal to half of the wavelength in the present example. In this respect, it may be desirable for the spacing to deviate slightly from the value of half of the wavelength of the signals, and the precise spacing that is adopted may be determined by trial and error or by computer modelling, for example, to tune the flow tube 22 to optimise the SNR at the receiving transducer 34. For example, the spacing of the blocks 32 may be within 10%, and optionally within 5% or even 2.5%, of half of the wavelength of the signals. In general terms, the intervals between adjacent blocks 32 may be sufficiently close to being equal to half of a wavelength that the nodes of the standing wave can locate in the tubular portions 64 between the blocks 32, taking account of the number of blocks 32 on the flow tube 22. The intervals between the blocks 32 may be measured between corresponding points on neighbouring blocks 32, such as respective axial midpoints of the blocks 32 or corresponding ends of the blocks 32, for example.

Meanwhile, the dimensions of the blocks 32, including the relative axial dimensions of the blocks 32 relative to the axial spaces between them, may be adjusted to enhance reflection at the frequency of the parasitic signal.

The geometry of the block structure has the effect of reflecting much of the energy of the unwanted signal at each block 32 to travel back towards the transmitting transducer 34, as evidenced by the formation of a standing wave within the walls of the flow tube 22 with nodes located in the tubular portions 64. While a small portion of the energy of the parasitic signal may continue past each block 32 to reach the receiving transducer 34, the vast majority of the energy of each parasitic signal is reflected at least once and so must take an extended path to reach the receiving transducer 34, so that the net effect is that the parasitic signal is effectively delayed. As reflection occurs at each block 32, the portion of the original parasitic signal that continues past each block 32 without ever being reflected, and thus is not delayed, diminishes at each block 32. The result is that the portion of the parasitic signal that is not delayed is so small that other sources of error tend to dominate, whilst also being predictable.

In practice, as a parasitic signal propagates through the wall 26 it causes resonance in each block 32 that it reaches, such that neighbouring blocks 32 effectively form resonators and define a node or null in the tubular portion 64 between them. This resonance reflects the acoustic energy of the parasitic signal, causing the parasitic signal to interfere with its own reflection and thus form a standing wave. Accordingly, neighbouring blocks 32 exhibit opposed, alternating acoustic pressure, namely positive or negative pressure, while there is substantially zero acoustic pressure in the nulls between the blocks 32.

The delaying effect is complemented by an attenuating effect due to the square shape of the blocks 32 in this example. In this respect, when considering the cross-section of an individual block 32 in radial coordinates, with an origin coinciding with the central axis of the flow tube 22, the path length from the centre to the outer edge of the block 32 varies strongly as a function of angle. This means that reflected signals from the steel-air interface at the outer surface of the block 32 are not coherent when they impinge back on the steel-fluid interface, and so their amplitude is reduced as a result of destructive interference. It is noted, however, that formations having other shapes can also provide an effective delay. In this respect, the principle of reduced coherence applies to blocks of any non-circular cross-section, and blocks with circular cross-sections can also be used.

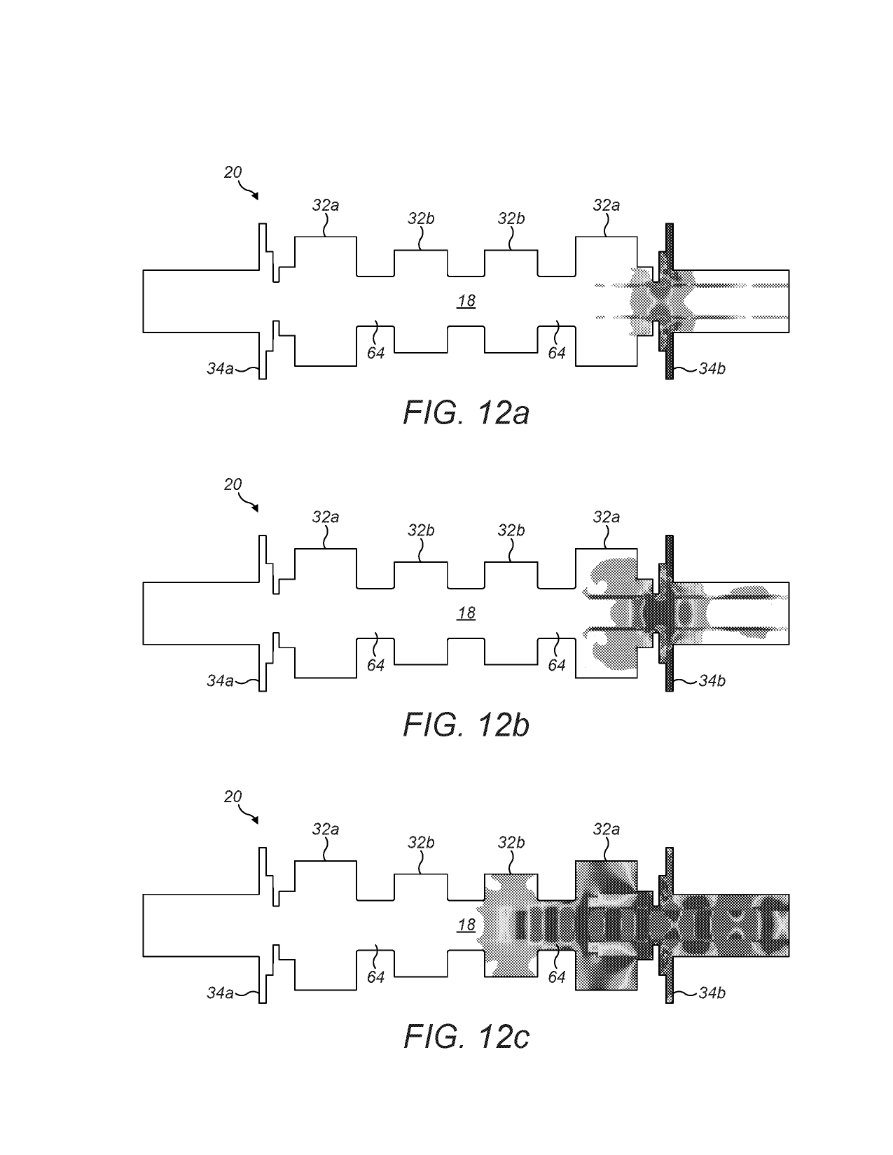

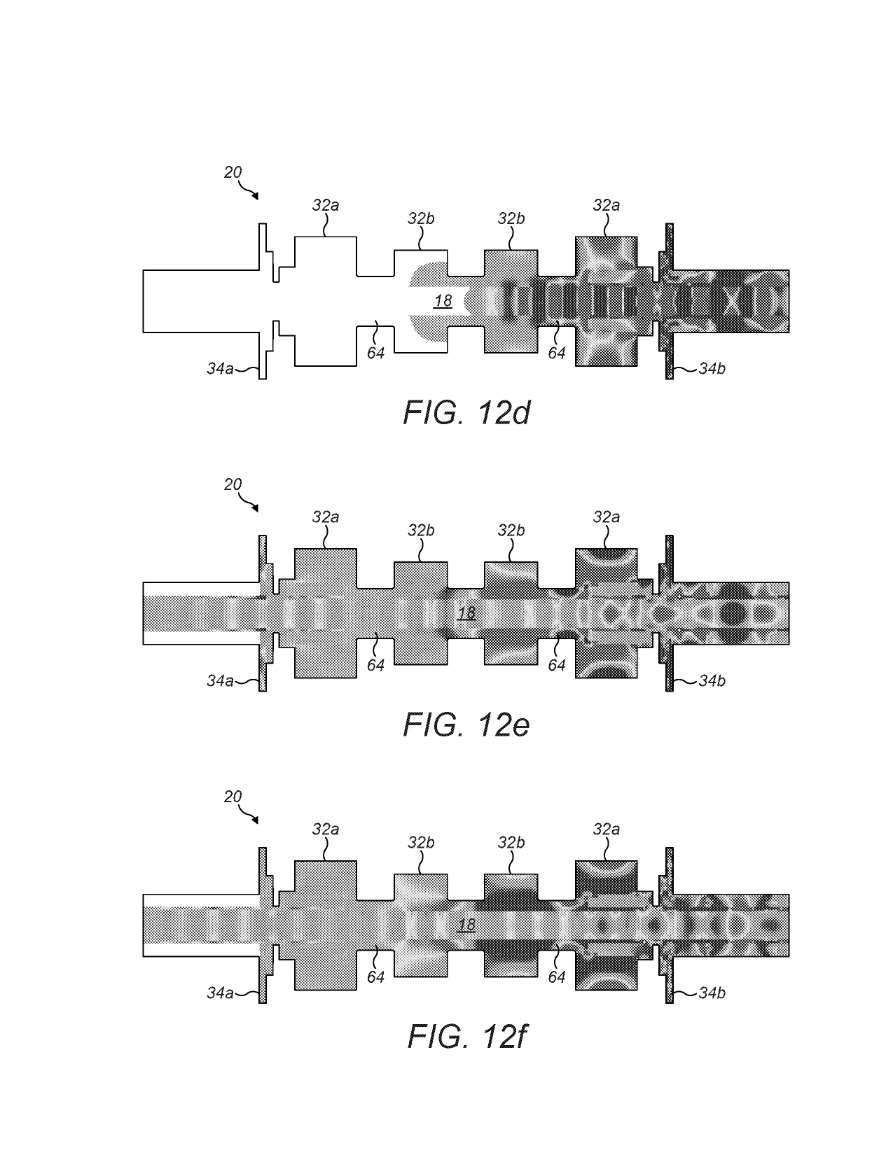

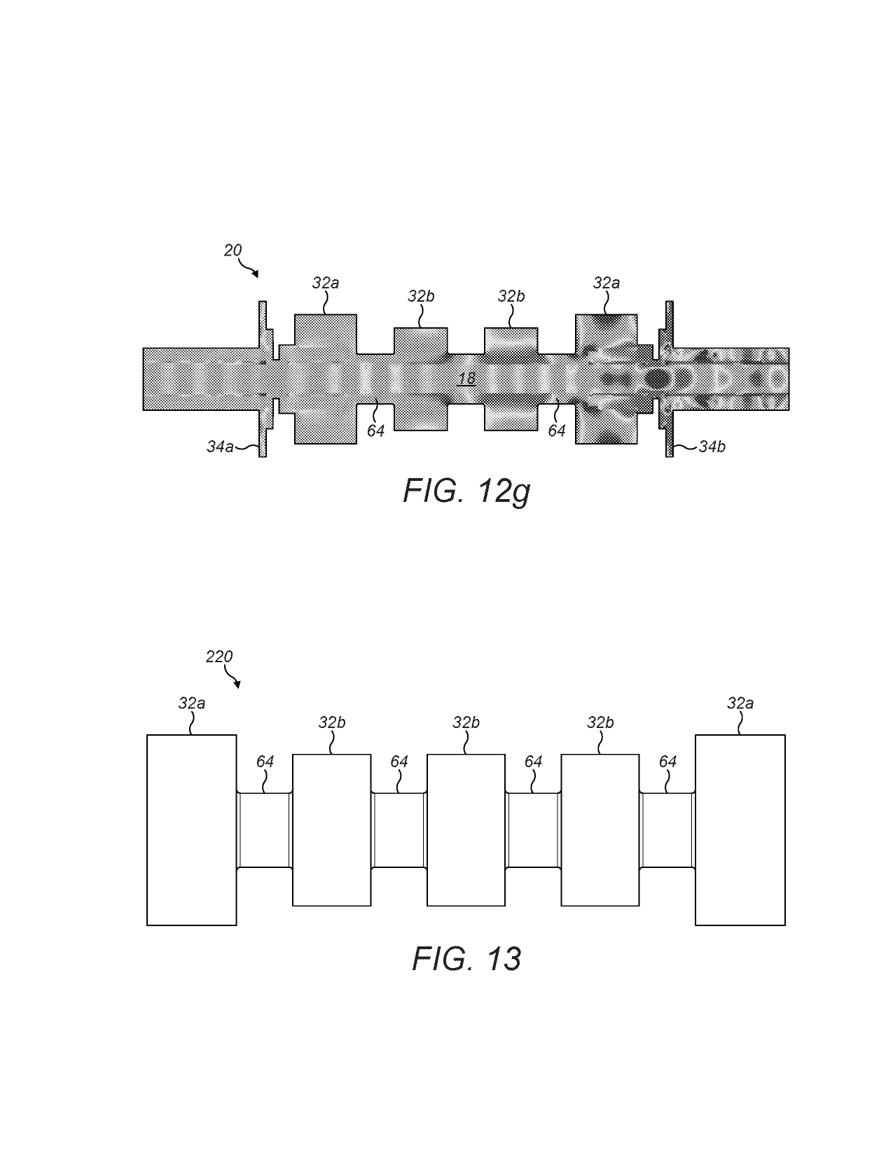

The above principles are illustrated in FIGS. 12a to 12g, which show a sequence of stages of a simulation of the flow tube assembly 20 in operation. Specifically, the sequence shows a transmission of a single signal composed of three pulses from the transmitting transducer 34, which is the second transducer 34b and is shown to the right of the image in FIG. 12a, towards the receiving transducer 34, which is the first transducer 34a and is shown to the left.

In the greyscale images, lighter areas correspond to regions of neutral or zero pressure, whereas darker regions show regions of strongly negative or positive pressure. Areas of positive and negative pressure may be distinguished by their relative tones, with the darkest areas corresponding to negative pressure. For example, in FIG. 12c a series of alternating differently coloured rectangular areas are visible within the measurement channel, the darker areas representing fluid at negative pressure and the lighter areas representing fluid at positive pressure, with the lightest tones in the spaces between the rectangular areas representing zero pressure.

FIG. 12a shows the state of the flow tube assembly 20 at 10.9 µs after the transmitting transducer 34b has been activated. At this stage, the transfer surface 57 in contact with the fluid in the flow channel 18 exerts positive pressure on the fluid. The fact that the axial extent of the transfer surface 57 is approximately half the wavelength of the transmitted signal ensures pistonic motion, which maximises the displacement of fluid along the central axis 30 and gives excellent coupling efficiency.

At the next stage of the simulation, shown in FIG. 12b and corresponding to 13.9 µs after activating the transmitting transducer 34b, the simulation shows rings of alternating positive and negative pressure begin to coalesce and form a pair of plane waves, which propagate along the central axis 30 in both directions.

Then, as shown in FIGS. 12c, 34.7 µs after activating the transmitting transducer 34b the wanted signal is propagating along the flow tube 22. Meanwhile, an unwanted signal defined by acoustic pressure in the wall 26 of the flow tube 22 is still substantially contained within the end block 32a nearest the transmitting transducer 34b. A node defined by a point of zero pressure has developed in the centre of the tubular portion 64 between the first two blocks 32, with negative pressure exhibited to the right of the node and positive pressure to the left.

FIG. 12d shows the state of the flow tube assembly 20 two microseconds later, at 36.7 µs after activating the transmitting transducer 34b, which corresponds to approximately half of one period of the simulated wave having elapsed relative to the state shown in FIG. 12c. At this stage, the node in the middle of the first tubular portion 64 has remained substantially stationary, while the pressure exhibited on each side of the node has reversed relative to the previous state. Specifically, negative pressure is shown to the left of the node and positive to the right. This illustrates that a standing wave has established in the wall 26 of the flow tube 22, in which there is little net movement of the unwanted signal, namely the parasitic signal propagating through the wall 26 of the flow tube 22, in the direction of the receiving transducer 34a.

FIGS. 12c and 12d together also show how the series of pulses emitted by the transmitting transducer 34b build up to form a pulse train that propagates from right to left whilst each pulse maintains a well-defined shape that is generally oblong in form, as illustrated in the images. This behaviour enables the flow meter 10 to measure a good, unweighted average of the fluid flow rate over the cross-section of the flow channel 18, yielding both high accuracy and low noise.

FIG. 12e shows the situation a short time later, at 94.2 µs after activating the transmitting transducer 34b. The wanted signal is now passing through the receiving transducer 34a and so can be captured and analysed. The standing wave in the wall 26 of the flow tube 22 has advanced towards the receiving transducer 34a and there is now a second node in the tubular portion 64 disposed between the two intervening blocks 32b, with negative pressure to the left of the node and positive pressure to the right.

Then, at 97.2 µs after activating the transmitting transducer 34b as shown in FIG. 12f, the position of the second node has not significantly changed, but the pressure to each side of that node has reversed so that it has negative pressure to the right and positive pressure to the left. This again demonstrates the standing wave behaviour of the arrangement.

Finally, FIG. 12g shows the state of the flow tube assembly 20 at 104.4 µs after activating the transmitting transducer 34b, at which point a sufficient portion of the wanted signal has now been received by the receiving transducer 34a to facilitate any analysis needed to determine an accurate value for the time-of-flight, as well as any other metrics that the control module 40 may calculate, such as the strength and any other useful characteristics of the wanted signal. The leftmost end block 32a now shows a slight net positive pressure, indicating that the parasitic signal is starting to reach the receiving transducer 34a. As the receiving transducer 34a has been switched off at this point, the delayed arrival of the unwanted signal does not impact the measurement.

FIG. 12g also shows that, even at the end of the sequence, very little acoustic pressure has reached the end block 32a nearest the receiving transducer 34a. This illustrates the effectiveness of the delay line created by the blocks 32, even without applying damping.

Following the sequence shown in FIGS. 12a to 12g, the flow meter 10 allows a sufficient period for the remaining acoustic energy in the flow tube assembly 20 to dissipate and then issues the next signal, which may travel in the opposite direction to enable a comparison of time-of-flight measurements and thereby derive the flow rate.

The above principles can be applied to a range of flow tube configurations. For example, the flow tube can effectively be stretched by adding further intervening blocks at the same spacing and of the same geometry, which may further enhance performance by extending the effective delay line. In this respect, FIG. 13 shows a variant of the flow tube 220 having one further intervening block 32b, which is identical to the intervening blocks 32b of the first example and at the same regular axial spacing. Further intervening blocks could be added in a similar manner. As the original parasitic signal diminishes at each block, adding further blocks has the effect of further reducing the portion of the original parasitic signal that reaches the receiving transducer without being delayed.

More generally, the flow tube and its blocks can be re-scaled and/or reconfigured in various other ways to achieve similar effects and to tune the arrangement for different signal frequencies. For example, as noted above the blocks may not have a square transverse cross-section as in the above examples, and may instead have oblong or circular cross-sections, for example. Instead of having larger end blocks, the blocks may all be of the same size, or the end blocks could be smaller than the intervening blocks. In broad terms, the geometry of the blocks and the spacing between them can be tailored and optimised for each application, for example to tune the blocks for the frequency of the signals to be used in the flow meter.

The axial length and/or spacing of the blocks could also be varied along the length of the flow tube to tune the flow tube to create an acceptable delay across a broader range of frequencies, rather than a single frequency as in the above examples. For example, blocks or other formations may be arranged in adjacent pairs, each pair having a spacing determined to delay signals of a particular wavelength, the pairs of blocks having different spacings and corresponding wavelengths so that the pairs collectively delay a range of wavelengths. With sufficient pairs of blocks at varying spacings, and noting that each pair provides an effective delay for a small range of frequencies, parasitic signals of any frequency within the operating range will encounter at least one pair of blocks that are spaced appropriately to create an effective delay. It is noted that in such examples the flow tube may still have a central plane of symmetry, in which case the flow tube would include two similar pairs of blocks for each wavelength, with one pair on each side of the plane of symmetry. It is also noted that an individual block may belong to two pairs of blocks at different spacings, in that a series of three blocks may define two pairs of blocks, the middle block belonging to both pairs and being offset towards one of the other blocks.

It is noted that a drive signal used to operate a transducer that is not purely sinusoidal typically contains frequency components that are close to, but not equal to, the fundamental frequency. For example, in a practical implementation a drive signal may ramp up from zero to full amplitude over a few cycles. This means that, even if the signal has a relatively narrow bandwidth, a corresponding FFT plot would not exhibit a perfectly thin vertical line. Accordingly, formations at varying spacing may be used to delay parasitic signals at the expected frequencies.

In addition, the blocks may not have planar radial faces at each axial end as in the above examples, but may be shaped differently. For example, blocks or other formations may have frusto-conical faces at each axial end. It is also possible for the flow tube to be shaped to create a series of relatively wide portions defining formations separated by relatively narrow portions without defining distinct blocks. For example, the exterior of the flow tube could have a sinusoidal profile in longitudinal cross-section, such that the formations may be regarded as merging into one another.

To summarise, the flow tube assemblies described above implement a range of measures that contribute to a high SNR for the flow meter in which the flow tube assembly is used. These measures include minimising the magnitude of parasitic signals by isolating the transducers from the wall of the flow tube using a carrier of a different material to support each transducer relative to the flow tube, and controlling the path of the signals between the transducers and the fluid to provide strong wanted signals at the receiving transducer. The relatively weak parasitic signals are then slowed as they propagate towards a receiving transducer by a set of formations on the flow tube that are tuned to create a delay line.

It will be appreciated by a person skilled in the art that the invention could be modified to take many alternative forms to that described herein, without departing from the scope of the appended claims.

For example, in some variants three or more transducers may be used. A transducer may be placed at the axial midpoint of the flow tube, with further transducers at each end of the flow tube. In such variants, each transducer may have a dedicated function as either a transmitter or a receiver. For example, if the central transducer acts as a transmitter, time-of-flight measurements may be taken in upstream and downstream directions simultaneously by transmitting opposed signals, each towards a respective receiving transducer. Such an arrangement would exploit the fact that the transducer may inherently send near-identical sound waves in opposite directions along the axis of the flow tube. This configuration could be reversed, however, so that the central transducer acts as a receiver.

Although in the example described above acoustic signals are transmitted to travel parallel to the axis of the flow channel, in other examples the transducers and flow channel may be arranged so that the acoustic path between the transducers is at an oblique angle relative to a central axis of the flow channel.

In the above example, the surface of the measurement channel is defined by the respective surfaces of the flow tube, the transfer surfaces of the transducer carriers and the liners, such that surfaces of the flow tube and the transducer carrier are in direct contact with the fluid. However, it is also possible for some or all of these surfaces to be coated with a layer of material, such that the flow tube and/or the transducer carrier is not in direct contact with fluid flowing through the measurement channel. Similarly, a sleeve could be inserted into the measurement channel to similar effect. In such embodiments, acoustic signals may be transferred between the transducer carriers and the fluid through the respective transfer surfaces via the coating or sleeve.

The flow tube assemblies described above include a flow tube and associated flow channel that is substantially straight. However, in other examples the flow tube and/or flow channel may be curved along some or all of its path. For example, U-shaped flow tubes are known, and the principles described above are applicable to such tubes, for example by adding formations to create a delay line for parasitic signals. For example, such a tube may have a pair of straight portions extending side-by-side in parallel, each resembling the flow tubes of the above examples and including a series of blocks that create a delay line, connected by a plain U-shaped portion that is without formations. Formations of alternative shapes may be used in other variants to accommodate the shape of the flow tube to avoid interfering with one another, particularly in curved portions of the tube, for example using formations having a trapezoidal transverse cross-section.

The transducer carrier may be used with a different flow tube to that described above. Indeed, the transducer carriers could be used with a simple straight tube without external formations, for example, while still providing the benefits of minimising generation of parasitic signals and providing an effective acoustic path between the transducers and the fluid, in turn leading to strong received signals, albeit potentially with stronger parasitic signals also.

What is claimed is:

1. An acoustic flow meter comprising:
a flow tube defining at least a portion of a passage through which fluid can flow and a flow tube axis extending longitudinally along the flow tube, the flow tube having a first end and a second end; and
two transducer assemblies, each assembly comprising:
a transducer carrier having a transfer surface forming a first portion of the passage,
wherein the transfer surface is directly exposed to the fluid and through which signals are transferred to a transducer; and
the transducer mounted to the transducer carrier, the transducer being operable to transmit the signals, receive the signals, or any combination thereof,
wherein a first transducer assembly of the two transducer assemblies is located at the first end of the flow tube and a second transducer assembly of the two transducer assemblies is located at the second end.

2. The acoustic flow meter of claim 1, wherein the two transducer assemblies are affixed to the respective first end and second send of the flow tube via threading.

3. The acoustic flow meter of claim 1, wherein at least a portion of the transducer carrier extends orthogonal to the flow tube axis.

4. The acoustic flow meter of claim 3, wherein the portion of the transducer carrier orthogonal to the flow tube axis is adjacent to the transducer.

5. The acoustic flow meter of claim 1,
wherein the transducer carrier is a plastic material,
wherein the transfer surface has an axial length, with respect to the flow tube axis, shorter than a wavelength within the transducer carrier of the signals from the transducer thereby enabling the transducer to better receive the signals.

6. The acoustic flow meter of claim 1, wherein the transfer surface has an axial length, with respect to the flow tube axis, within 10% of half of a wavelength of the signals from the transducer thereby enabling the transducer to better receive the signals.

7. The acoustic flow meter of claim 1, further comprising:
at least one liner configured to be received within the flow tube to surround the passage,
wherein the at least one liner is a different material than at least the transfer surface.

8. The acoustic flow meter of claim 7, wherein the passage has a substantially uniform diameter after the at least one liner is within the flow tube.

9. The acoustic flow meter of claim 7, wherein the at least one liner is a steel tube.

10. The acoustic flow meter of claim 7, wherein the at least one liner abuts the transfer surface to define the passage.

11. The acoustic flow meter of claim 1, wherein the fluid is vehicle fuel.

12. A fluid circuit of a vehicle comprising:
the acoustic flow meter of claim 1, configured to measure a flow rate of vehicle fuel through a portion of the fluid circuit of the vehicle.

13. A flow meter comprising:
a first transducer configured to transmit a first signal and receive a second signal,
wherein the first transducer is located at a first end of a fluid passage;
a first transfer surface exposed to a fluid in the fluid passage and configured to transfer the second signal to the first transducer;
a second transducer configured to transmit the second signal and receive the first signal,
wherein the second transducer is located at a second end of the fluid passage;
a second transfer surface exposed to the fluid in the fluid passage and configured to transfer the first signal to the second transducer;
a controller configured to:
determine a flow rate of fluid through the fluid passage based on a difference between a time-of-flight of the first signal and a-time-of-flight of the second signal.

14. The flow meter of claim 13, wherein the first transfer surface and the second transfer surface are an acoustically conductive material, compared to a remainder of an interior of the fluid passage, to transfer the first signal and the second signal to the first transducer and the second transducer, respectively.

15. The flow meter of claim 13, wherein the first transfer surface has an axial length, with respect to an axis of the fluid passage, within 10% of half of a wavelength of the signals from the transducer.

16. A method for determining a flow rate through a fluid circuit of a vehicle, the method comprising:
transmitting, from a first transducer on a first end of a flow tube, a signal traveling through a fluid in the flow tube to a second end of the flow tube;
transferring, to a second transducer on the second end of a flow tube, the signal through a second transfer surface adjacent to the second transducer;
transmitting, by the second transducer, a second ultrasonic signal traveling through the fluid in the flow tube to the first end of the flow tube;
transferring, to the first transducer, the second signal through a first transfer surface adjacent to the first transducer; and
determining, via a controller, a flow rate of the fluid based on a difference between a time-of-flight of the first signal and a-time-of-flight of the second signal.

17. The method for determining the flow rate of claim 16, further comprising:
mitigating, via a set of blocks spaced along the flow tube, parasitic signals propagating through the flow tube to reduce an extent to which the parasitic signals reach the first transducer before the second signal.

18. The method for determining the flow rate of claim 17, wherein the set of blocks have a non-circular cross-section.

19. The method for determining the flow rate of claim 16, wherein the first transfer surface has an axial length within 10% of half of a wavelength of the second signal.

20. The method for determining the flow rate of claim 16, further comprising:
directing a portion of the second signal to travel through the first transfer surface
based on the first transfer surface having a first material which is closer in acoustic impedance to the fluid than adjacent materials in the flow tube.
